(19) United States
(12) Patent Application Publication
(10) Pub. No.: US 2008/0088244 A1
(43) Pub. Date: Apr. 17, 2008

(54) Variable Color Illumination Apparatus

(75) Inventor: Masazumi Morishita, Tokyo (JP)

Correspondence Address: BIRCH STEWART KOLASCH & BIRCH, PO BOX 747, FALLS CHURCH, VA, 22040-0747, US

(73) Assignee: Sugatsune Kogyo Co., Ltd., Tokyo (JP)

(21) Appl. No.: 11/795,579

(22) PCT Filed: Jan. 20, 2006
(86) PCT No.: PCT/JP06/00823

§ 371 Date: Sep. 13, 2007

(30) Foreign Application Priority Data
Jan. 20, 2005 (JP) 2005-012753

(51) Int. Cl. H05B 41/38

(52) U.S. Cl. 315/154

(57) ABSTRACT

To provide a variable color illumination apparatus enabling illumination with a suitable colors even when characteristics change in accordance with aging or other aspects of the environment and having a reproducibility of colors stable for a long period. The variable color illumination apparatus has light sources (15) of at least two colors, a control device (30) for independently performing light adjustments of the respective light sources (15), one light receiving device (83) for detecting light emission amounts of light sources (15), a memory device (71) storing light quantity ratios of the respective light sources (15) preset for obtaining desired light colors, and a central processing unit (50) for finding changes between light quantity ratios of the respective light sources (15) detected at the light receiving device (83) and preset light quantity ratios and outputting the changes as correction outputs to the control device (30).

### TECHNICAL FIELD

This relates to an illumination apparatus enabling illumination by a more suitable color in accordance with the environment and having a reproducibility of color stable for a long time.

### BACKGROUND ART

White light is obtained by combining the minimum required three primary colors of R (red), G (green), and B (blue) by each of light quantity ratios adapted to the light with natural light.

However, even when running the same current through the same type of light emitting diodes (LEDs), since the characteristics of the individual LEDs will differ, the exact same light quantities will not be obtained. Further, when considering one LED, the light emitting characteristic will deteriorate along with time. Due to the degraded characteristic on such aging, when, for example, using three color LEDs of R, G, and B to compose light, by the aging of the respective LEDs, a color can not maintain the same color as initially composed.

To compensate such a change of the composed light, it is possible to maintain the desired composed light by measuring the lights generated at the LEDs with light receiving devices and changing the currents run through the respective LEDs so as to correct the values changed from the initial settings.

Such an example is disclosed in, for example, Patent Document 1 (Japanese Patent Publication (A) No. 5-21168) and Patent Document 2 (Japanese Patent Publication (A) No. 60-124398).

FIG. 12 shows the configuration of a circuit of a conventional variable color illumination system 100.

The variable color illumination system 100 has a lighting apparatus unit 101, a light adjustment control unit 102 including a reception side CPU 116 etc., and a remote control operation unit 103 including a light color/light quantity detection unit 115 (hereinafter referred to as a remote control unit).

The lighting apparatus unit 101 comprises a light source unit 104 having three light sources having light emission colors of the three primary colors R, G, and B and a light adjustment device 105 for both driving this light source unit 104 to turn on and adjusting the light. The light adjustment device 105 drives the light source unit 104 in accordance with a light adjustment signal S102 output from the light adjustment control unit 102.

A light signal is sent to the light adjustment control unit 102 via a transmission device (light emitting diode D2) of the remote control unit 103 and is received by a light receiving device (photodiode D1) connected to a signal reception unit 109. The light adjustment control unit 102 comprises a reception side CPU 116 for performing processing for judgment of setting signals and data of received signals, performing processing for light adjustment, and outputting a control signal in accordance with the result thereof, an RGB light adjustment ratio reference data memory unit 107, and an RGB light adjustment ratio correction value data memory unit 108.

The reception side CPU 116 comprises a signal reception unit 109, a mixed color light setting/mixed color light detection value judgment unit 110, a mixed color light setting storage unit 111 for storing output values of the mixed color light setting/mixed color light detection value judgment unit 110, a mixed color light detection value storage unit 112, a light color/light quantity comparison and judgment unit 113, and an RGB light adjustment signal generation unit 114. It performs processing for judgment of a signal received at the light receiving device D1 and further performs processing for light adjustment and outputs a control signal S102 to the light adjustment device 105 of the lighting apparatus unit 101 in accordance with the result.

The light color/light quantity detection unit 115 forming part of the remote control unit 103 comprises three light receiving devices (photodiode) and amplifiers having a processing and amplification circuit and a resistor corresponding to the number of the respective RGB light sources of the light source unit 104 and detects the light colors of the respective RGB light sources and their light quantities.

Signals output from three detectors of the light color/light quantity detection unit 115 are output to an A/D conversion unit 116 where the analog signals are converted to digital signals. A transmission side CPU 117 comprises a processing unit 119 and a signal transmission unit 120. The processing unit 119 performs processing by using the light color/light quantity data of the respective RGB light sources digitalized via the A/D converter 116 and data sent from the light color/light quantity setting unit 118. The signal transmission unit 120 converts the processing results sent from the processing unit 119 into, for example, pulse signals, and drives the transmission device D2 to transmit by, for example, the pulse signals.

When setting the light color/light quantity, the desired values (data) are input by the light color/light quantity setting unit 118 of the remote control unit 103, and then sent to the signal transmission unit 120 via the processing unit 119 where the transmission device (light emitting diode) D2 is driven to transmit them toward the receiving device (photodiode) D1. The sent signals are received by the receiving device D1 and signal reception unit 109 of the light adjustment control unit 102, then the mixed color light setting/mixed color light detection value judgment unit 110 judges whether or not they are mixed color light settings or mixed color light detection values.

The case of the mixed color light setting is being explained now, therefore the mixed color light setting/mixed color light detection value judgment unit 110 stores the sent light color/light quantity setting values in the mixed color light setting storage unit 111. These stored values are output to the RGB light adjustment signal generation unit 114 and the light color/light quantity comparison and judgment unit 113. The light color/light quantity comparison and judgment unit 113, because this is the case of mixed color light settings, transfers the data with the RGB light adjustment ratio reference data memory unit 107, finds coordinate values of the mixed color light from the light colors/light quantities of the chromaticity coordinates, and finds the R, G, and B light quantity ratios. The light adjustment ratios of the RGB light sources with respect to any set light are stored as a table in the RGB light adjustment ratio reference data memory unit 107.

The data for controlling the RGB light sources read out from the RGB light adjustment ratio reference data memory unit 107 is supplied to the RGB light adjustment signal generation unit 114 and output as a control signal S102 to the light adjustment device 105 of the lighting apparatus unit 101. The light adjustment device 105 performs the light adjustment (generation of electric signals) of the RGB light sources based on the control signal S102 and drives each of light sources (R, G, B) of the light source unit 104.

Next, a case where the light colors/light quantities output from the respective light sources of the light source unit 104 deviate from the settings due to aging etc. will be explained.

The mixed color light of, for example, the three LEDs output from the light source unit 104 is irradiated to the light color/light quantity detection unit 115 of the remote control unit 103. The three detectors (X2, Y, Z) of the light color/light quantity detection unit 115 detect the light wavelengths (light colors) and their intensities (light quantities). The analog data (signals) of the detected values are converted to digital data at the A/D conversion unit 116 and then output to the transmission CPU 117. The processing unit 119 processes the chromaticity coordinates (x0, y0) and the light quantity Y0 of the measured light and supplies the results to the signal transmission unit 120.

The chromaticity coordinates (x0, y0) and light quantity Y0 data of the mixed color light are supplied via the transmission device D2, receiving device D1, and signal reception unit 109 to the mixed color light setting/mixed color light detection value judgment unit 110. The mixed color light setting/mixed color light detection value judgment unit 110 judges these as mixed color light detection signals and stores the detected values in the mixed color light detection value storage unit 112. Respective output values from the mixed color light setting storage unit 111 storing values set by the light color/light quantity setting unit 118 of the remote control unit 103 therein and from the mixed color light detection value storage unit 112 storing the detected data therein are supplied to the light color/light quantity comparison and judgment unit 113. Then, the light color/light quantity comparison and judgment unit 113 detects amounts of deviation between the setting values and the detection values.

The data of the amounts of deviation between the setting values and detection values detected at the light color/light quantity comparison and judgment unit 113 is supplied to the RGB light adjustment ratio correction value data memory unit 108. This RGB light adjustment ratio correction value data memory unit 108 stores for example the light adjustment ratios of the mixed color light and correction coefficients for the light color correction, and the data corresponding to correction values are output to the RGB light adjustment signal generation unit 114. The RGB light adjustment signal generation unit 114 generates light adjustment signals by using the light adjustment ratio correction values (data). Respective LEDs of the light source unit 104 of the lighting apparatus unit 101 are driven via the light adjustment device 105. As a result, the settings are adjusted by exactly the amounts of deviation from the setting values, respective LEDs of the light source unit 104 are driven to turn on, and mixed color light having the light color/light quantity of the target setting values is generated.

As disclosed in Patent Document 2 (Japanese Patent Publication (A) No. 60-124398), for the light receiving device for measuring the light color, the method of forming the light receiving device by three devices having broad band luminosity factors corresponding to the light sources is known. That is, it is known to comprise the light receiving device with devices having sensitivity regions called Bx·By·Bz (here, Bx indicates x bar, By indicates y bar, and Bz indicates z bar, respectively) of chromaticity coordinates regarded the same as the luminosity factors. In this sensitivity region, the sensitivity is expanded up to one or more wavelength regions of the used LEDs, therefore it was necessary to compute the values of R, G, and B from the obtained measurement values.

Patent Document 1: Japanese Patent Publication (A) No. 5-172863

Patent Document 2: Japanese Patent Publication (A) No. 60-124398

### DISCLOSURE OF THE INVENTION

### Problem to be Solved by the Invention

For this reason, three light receiving devices and three amplifiers for amplifying detection currents etc. obtained from the light receiving devices, the same number as the light receiving devices, are necessary, so the occupied area became wide and the price became large.

Further, correction values are found by processing the measurement values, therefore a CPU (Central Processing Unit) with high grade computation functions and high speed operation will become necessary.

### Means for Solving the Problem

An object of the present invention is to overcome the above problem.

According to the present invention, there is provided a variable color illumination apparatus operating in an ordinary lighting mode for simultaneously turning on respective light sources and in a light quantity adjustment mode for adjusting light quantities of the respective light sources, the variable color illumination apparatus comprising light sources of at least two colors for composing light, a control device for independently performing light adjustment of respective light sources, single light receiving device for detecting light emitting amounts of the light sources, a memory device for storing a light quantity ratio of each of the plurality of light sources preset for obtaining a desired light color, and a processing device for finding a difference between a light quantity ratio preset for obtaining a desired light color stored in the memory device and a light emitting amount detected at the light receiving device, the control device simultaneously driving the light sources in the ordinary lighting mode, the control device sequentially driving the plurality of light sources at time intervals in the light quantity adjustment mode, the processing device finding the difference between a light quantity ratio preset for obtaining a desired light color stored in the memory device for a light source driven at that time and a light emitting amount of the driven light source detected at the light receiving device and transmitting the difference to the control device (30), and the control device driving the light source by using the input difference as correction output of the driven light source so as to control the light emitting amount of the light source.

Namely, in the light quantity adjustment mode, one light receiving device having a sensitivity in the visible region is disposed between the light source and a light projection position, for example, the R, G, and B LEDs are lit with a time difference, a time during which only one color LED is simultaneously turned on is provided, and the light quantity is measured at that time.

### EFFECTS OF THE INVENTION

According to the present invention, a light quantity adjustment mode is provided in addition to the ordinary lighting mode. In the light quantity adjustment mode, the light emitting amount of each light source is detected. Adjustment was enabled when a light source device deteriorated in characteristics.

In the present invention, the number of light receiving devices (including for example amplifiers) may be one. Therefore, the circuit configuration can be greatly reduced and the price of the apparatus is lowered in comparison with the conventional case where three light receiving devices are required.

Further, according to the present invention, the measurement time becomes, for example, 1/100 second or less. So, not sensed by the human eye, there is no substantial influence on the illumination apparatus.

Further, the light emission intensity of each of R, G, and B can be independently obtained only by timing, therefore complex processing becomes unnecessary, and an expensive processing means having a high processing capability, for example, a computer, becomes unnecessary.

### BRIEF DESCRIPTION OF THE DRAWINGS

FIG. 1 is a view of the configuration of a variable color illumination apparatus of an embodiment of the present invention.

FIG. 2 is a flow chart for explaining an operation of the variable color illumination apparatus shown in FIG. 1.

FIG. 3 is a flow chart for explaining another example of operation of the variable color illumination apparatus shown in FIG. 1.

FIG. 4 is a diagram showing the configuration of the variable color illumination apparatus shown in FIG. 1.

FIG. 5 is a flow chart showing production steps of the variable color illumination apparatus shown in FIG. 4.

FIG. 6 is a flow chart showing other production steps of the variable color illumination apparatus shown in FIG. 4.

FIG. 7 is a chromaticity diagram using RGB light sources used for explaining the operation of the variable color illumination apparatus of FIG. 1.

FIGS. 8A and 8B are spectral distribution diagrams of various types of light sources.

FIG. 9 is a graph showing light emission efficiencies and service lives of various types of light sources.

FIG. 10 is a spectrum diagram of a white LED.

FIG. 11A to FIG. 11F are graphs showing spectral distribution characteristics when light sources irradiate a specimen.

FIG. 12 is a block diagram of the configuration showing the overall blocks of a conventional variable color illumination apparatus.

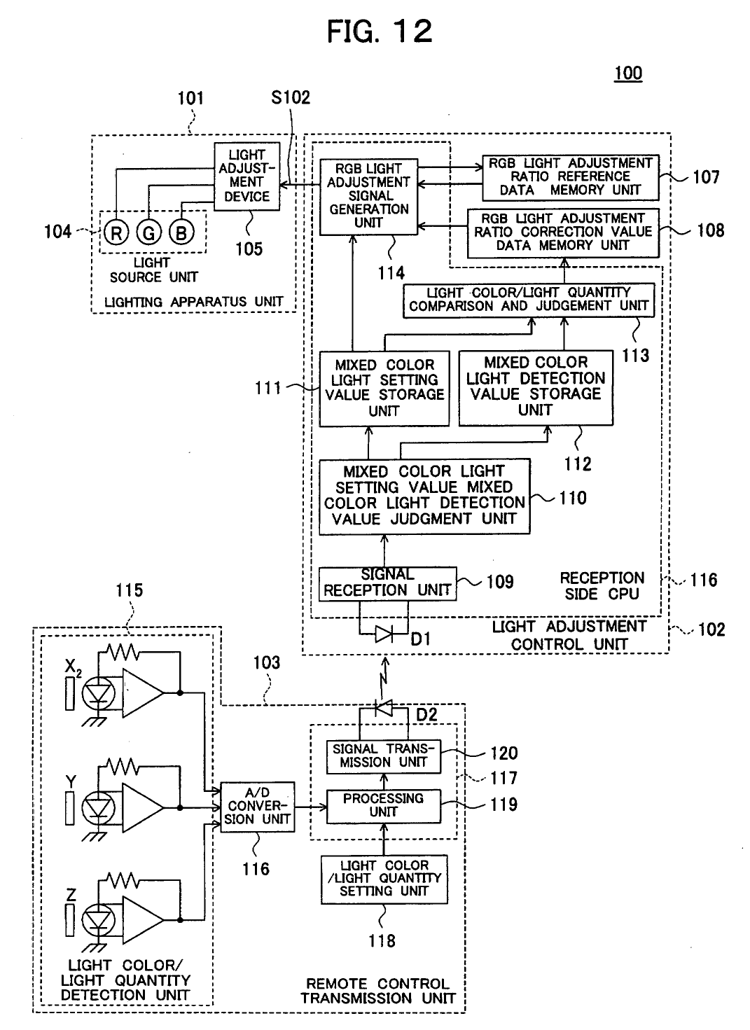

### DESCRIPTION OF NOTATIONS

10—variable color illumination apparatus, 15—light source unit, 21 to 23—LED drivers, 91 to 93—LED drivers, 30—RGB light adjustment pulse generation device, 50—CPU (Central Processing Unit), 51—limit output value storage unit, 52—comparison unit, 53—present output value storage unit, 54—output value transmission and control unit, 55—output value processing unit, 56—measurement result RGB ratio processing unit, 57, 95—A/D conversion units, 58, 94—timing generation units (circuits), 60—display device, 70—external nonvolatile memory, 71—production time (initial) RGB ratio storage unit, 72—last output value storage unit, 80—light detection unit, 82—amplifier, 83, 89—light receiving devices, 86—R (red) LED, 87—G (green) LED, and 88—B (blue) LED.

### BEST MODE FOR CARRYING OUT THE INVENTION

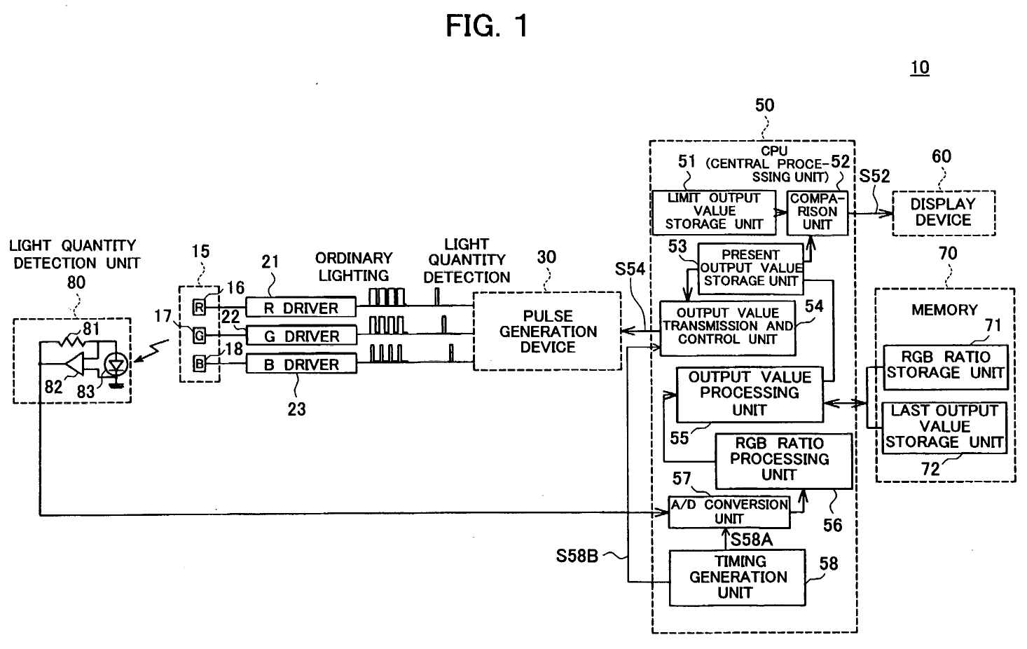

FIG. 1 is a view of the configuration of a variable color illumination apparatus 10 of an embodiment of the present invention.

The variable color illumination apparatus 10 comprises a light source unit 15, drive circuits (drivers) 21 to 23, a light adjustment pulse generation device 30, a processing device 50, for example, a CPU of a computer, a display device 60, an external nonvolatile memory 70 provided outside of the processing device 50, and light quantity detection unit 80.

Although the light quantity detection unit 80 illustrated in FIG. 1, a light receiving device, for example, one photodiode, is shown, when three LEDs 16 to 18 in the light source unit 15 independently light up, it is also possible to use a plurality of light receiving devices matched with the number of LEDs 16 to 18 in the light source unit 15 so as to detect the lights. A function equivalent to one light receiving device can be achieved.

Note that in the following description, the case of one light receiving device (photodiode) will be explained.

The light source unit 15 comprises for example a R (red light emitting)-LED, Y (yellow light emitting)-LED, and B (blue light emitting)-LED and so on.

LEDs were developed from ones emitting long wavelength infrared rays. Shorter wavelength ones were then successively developed. The recent development of blue LEDs had enabled production over the entire visible light range.

Light composed by operation of a blue light emitting LED and a LED having blue light emitting LED with a yellow phosphor attached appears white, therefore white LEDs have appeared on the market and are garnering attention for illumination use.

The characteristic features of LEDs will be explained first.

A first characteristic feature of LEDs resides in the generation of light having a high luminance from a small area. Since the area is small, it becomes possible to focus it to a small spot and illuminate a small area. Further, it also becomes possible to create images on large screen outdoor televisions, billboards, etc.

A second characteristic feature of LEDs resides in the longer service life in comparison with light sources used in other lighting apparatuses. Red LEDs, yellow LEDs, and other conventionally produced LEDs have very long times until their light quantities are halved, that is, 200,000 hours or more. However, the recently developed blue LEDs and white LEDs have remained lives of just 10,000 to 20,000 hours at the present point of time.

A third characteristic feature of LEDs resides in the emission of light at a low temperature. An LED is made of a semiconductor material, therefore is never used heated to a high temperature like with other lighting apparatuses (for example halogen lamps, fluorescent lamps, and metal halide lamps). For this reason, the problem of countermeasures against temperature due to the high temperature does not occur. Further, an LED is sealed air-tight as package, so usage in a closed place, bathroom, wet place, etc. becomes possible.

A fourth characteristic feature of LEDs resides in that selection of the types of LEDs enables free expression of color. LEDs emitting light of almost all colors in the range of visible light have been developed, therefore, by combining LEDs, all types of colors can be expressed. For example, a lighting apparatus having good light reproduction near natural light can be configured. Further, for commercial use, illumination which is colorful and can be changed in color becomes possible. This is very different from the inability of conventional neon tubes and fluorescent lamps to be changed in color from the color determined at the time of the production.

However, as the amount of light of one LED is limited, a large number of LEDs becomes necessary for obtaining the same light quantity as that of other lighting apparatuses and therefore the initial costs (production price) tend to become higher. However, a variable color illumination apparatus using LEDs making good use of the characteristic features of LEDs explained above is desired.

An embodiment using LEDs in the light source unit 15 will be shown.

A case where the light source unit 15 is provided with an R (red light emitting)-LED 16, a G (green light emitting)-LED 17, and a B (blue light emitting)-LED 18 will be exemplified.

The driver circuits 21 to 23 are an R driver 21 for driving the R-LED 16, a G driver 22 for driving the G-LED 17, and a B driver 23 for driving the B-LED 18. These drivers 21 to 23 are supplied with LED drive use input signals, for example, voltages having pulse waveforms. Signals obtained by converting these voltage pulses into current pulses are supplied to the R-LED 16, G-LED 17, and B-LED 18 of the light source unit 15. These LEDs emit lights with light quantities in accordance with their currents for exactly a time proportional to a pulse period.

The light adjustment pulse generation device 30 generates light adjustment pulses for driving the R-LED 16, G-LED 17, and B-LED 18 based on a signal S54 supplied from the output value transmission and control unit 54 in the CPU (Central Processing Unit) 50.

The variable color illumination apparatus 10 operates in the ordinary lighting mode and the light quantity adjustment mode. The modes are managed by the output value transmission and control unit 54 serving as the control device of the present invention.

The ordinary lighting mode is a mode providing ordinary illumination light. In this mode, the R-LED 16, G-LED 17, and B-LED 18 are simultaneously driven to generate the mixed color light of their light emission colors for use for illumination etc.

The light quantity adjustment mode is a mode periodically arriving between ordinary lighting modes and adjusting the light quantities of the light source unit 15 in a short time. At the time of this light quantity adjustment mode, the light adjustment pulse generation device 30, in accordance with the control signal S54 from the output value transmission and control unit 54, prevents the R-LED 16, G-LED 17, and B-LED 18 from simultaneously turning on by, for example, preventing the pulse for driving the R driver 21, the pulse for driving the G driver, and the pulse for driving the B driver from overlapping each other. In other words, in the light quantity adjustment mode, the output value transmission and control unit 54 outputs the control signal S54 for driving the LEDs 16 to 18 in a time sequence of such a timing to the light adjustment pulse generation device 30.

The limit output value storage unit 51 is configured by a memory storing limit values of light quantities output from the respective LEDs in the light source unit 15. For example, the service lives of the R-LED 16, G-LED 17, and B-LED 18 are stored in the limit output value storage unit 51 in advance as limit values of the values when the output light quantities measured are reduced to about ½ from their initial values due to aging etc.

The present output value storage unit 53 stores the setting values of the R-LED 16, G-LED 17, and B-LED 18 for obtaining the desired mixed color light and light quantity at the time of the ordinary lighting mode. Further, the present output value storage unit 53 stores data for correcting amounts of deviation from the setting values (reference values) at the time of the light quantity adjustment mode.

The comparison unit 52 receives as input values corresponding to the service lives of the respective LEDs output from the limit output value storage unit 51 and setting values for driving the respective LEDs stored in the present output value storage unit 53. The comparison unit 52 compares the both. If the present output value of a certain LED is smaller than the limit output value, it outputs a control signal to the display device 60 and displays that the LED has reached the end of its service life.

Conversely, when the present output value is larger than the limit output value, the comparison unit 52 does not have to output the control signal to the display device 60. However, for example, in response to a request from a user, a display indicating that all of R-LED 16, G-LED 17, and B-LED 18 are normal can be performed on the display device 60.

The A/D conversion unit 57 converts the analog voltage value of the light quantity output from any of the R-LED 16, G-LED 17, and B-LED 18 detected at the light quantity detection unit 80 to digital data at a timing in accordance with a clock or other timing signal S58A output from the timing generation unit 58. Note that the timing signal S58A generated at the timing generation unit 58 includes a certain amount of delay from the timing pulse for driving the R-LED 16, G-LED 17, and B-LED 18 from the light adjustment pulse generation device 30 via the drivers 21 to 23 by the output value transmission and control unit 54 by generating a control signal S54 based on the timing signal S54B transmitted to the output value transmission and control unit 54. The delay time is determined by considering delays etc. of drive timings of the respective LEDs and the detection timing of the light quantity detection unit 80. As a result, the A/D conversion unit 57 can convert the light quantity of an LED in synchronization with the light emission of the LED.

In the present embodiment, there is a single light quantity detection unit 80, therefore the light quantities of all of the LEDs 16 to 18 of the light source 15 cannot be measured by a single measurement. For this reason, as explained above, the respective LEDs are driven in a time sequential manner and their light quantities are A/D converted so that their measurement times do not overlap.

The conversion operation by the A/D conversion unit 57 in the light quantity adjustment mode is carried out three times at the most matching with the three LEDs, but the operation period is very short, for example, about 1/100 second. This is a negligible period for the human eye. There is no substantial influence on the ordinary lighting mode.

The RGB ratio processing unit 56 performs processing for finding the ratios of the measurement values of the respective LEDs and reference values by using digital values indicating light emission amounts of the R-LED 16, G-LED 17, and B-LED 18 output from the A/D conversion unit 57. The RGB ratio processing unit 56 is configured as part of the processing device 50 and can calculate the ratios by making good use of the processing functions of the CPU of the computer.

The output value processing unit 55 is, for example, supplied with the light color and light quantity data stored in the RGB ratio storage unit 71 of the external nonvolatile memory 70 at the time of production (initial stage) and the data output from the RGB ratio processing unit 56, compares the both, performs processing based on the results of comparison to find the amounts of deviation from the previously set reference RGB ratios, and calculates the last output values and outputs them to the present output value storage unit 53 and the last output value storage unit 72 of the external nonvolatile memory 70, respectively. The last output value storage unit 72 is a nonvolatile memory, therefore, for example, even in a case where the variable color illumination apparatus 10 loses power, the values are retained.

The output value transmission and control unit 54 is supplied with the data at the time of the ordinary lighting mode or the data at the time of the light quantity adjustment mode output from the present output value storage unit 53 and outputs the data or correction data for driving the R-LED 16, G-LED 17, and B-LED 18 to the pulse generation device 30 according to the timing signal S58B supplied from the timing generation unit 58.

The light adjustment pulse generation device 30 converts the data or correction data for driving the R-LED 16, G-LED 17, and B-LED 18 into pulse waveforms according to the control signal S54 output from the output value transmission and control unit 54 and output pulses according to the timing at the time of the ordinary lighting mode or the timing at the time of the light quantity adjustment mode.

The external nonvolatile memory 70 provided outside of the central processing unit 50 is configured by the RGB ratio storage unit 71 storing initial values of the apparatus or RGB ratios at the time of production and the last output value storage unit 72.

The RGB ratio storage unit 71 stores values such as the light emission intensities (amplitudes) of the respective LEDs 16 to 18 preset to give a light emission color and light quantity desired by the user at the time of shipment of the variable color illumination apparatus 10.

The RGB ratio processing unit 56 processes the ratios with the reference RGB. Using the values, the output value processing unit 55 makes a comparison with the reference RGB ratios to find the corrected values for the light quantity adjustment mode. These values are stored in the last output value storage unit 72.

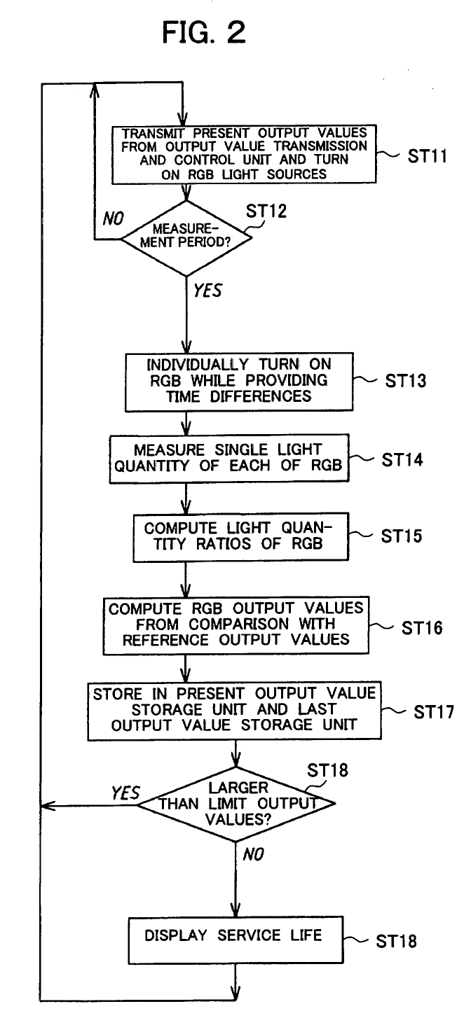

The operation of the variable color illumination apparatus 10 shown in FIG. 1 will be explained with reference to the flow chart of FIG. 2.

At step ST11, the output value transmission and control unit 54 is supplied with the present output values from the present output value storage unit 53.

At step ST12, the output value transmission and control unit 54 judges whether the mode is the ordinary lighting mode or the light quantity adjustment mode.

In the case where the timing is not the light quantity adjustment mode, that is, in the case where the timing is the ordinary lighting mode, the routine returns to step ST11 where the output value transmission and control unit 54 supplies the control signal S54 including pulses for the ordinary lighting mode to the light adjustment pulse generation device 30 based on the next (present output value) data. Ordinary lighting pulses output from the light adjustment pulse generation device 30 based on the control signal S54 are supplied to the R driver 21, G driver 22, and B driver 23 whereby the R-LED 16, G-LED 17, and B-LED 18 turn on and the desired composed light color and light quantity are obtained. This state is continued until the present values are input from the next present output value storage unit 53.

At step ST12, when the output value transmission and control unit 54 judges that the period for the light quantity adjustment mode is reached, the routine shifts to step ST13 where the control signal S54 including the light quantity control data and timing control signal output from the output value transmission and control unit 54 is output to the light adjustment pulse generation device 30 and pulses not overlapping on each other in terms of time are generated so as to turn on the LEDs in for example a sequence of R-LED 16, G-LED 17, and B-LED 18 and supplied as drive pulses to the R driver 21, G driver 22, and B driver 23.

For example, the light emitted from the R-LED 16 driven by the R driver 16 is converted into current by detecting the light at the light receiving device (photodetector) 83 of the light detection unit 80, this light current is converted into an analog voltage by the amplifier configured by the resistor 81 and processing and amplification circuit 82, and the signal voltage is output. The detected analog voltage is converted into a digital value at the A/D conversion unit 57.

Regarding the G-LED 17 and B-LED 18 driven shifted in time at predetermined time intervals as well, light currents are output as analog voltages after the light-current conversion at the light detection unit 80 in the same way as the above and converted into digital values at the A/D converter 57 (step ST14).

At step ST15, the RGB ratio processing unit 56 finds the RGB light quantity ratios by using digitalized light quantity data of the measurement results of the R-LED 16, G-LED 17, and B-LED 18 output from the A/D conversion unit 57.

At step ST16, based on the (initial) value at the time of production or the reference values set after that stored in the RGB ratio storage unit 71 and the data obtained at step ST15, the output value processing unit 55 performs the comparison processing to finds the amounts of deviation etc. due to aging and obtain the RGB output values.

At step ST17, the output value processing unit 55 outputs RGB output values obtained at step ST16 to the present output value storage unit 53 and the last output value storage unit 72 and stores them in storage units.

The RGB output values stored in the present output value storage unit 53 are supplied to the comparison unit 52. Further, the limit service life values of the respective LEDs 16 to 18 of the light source 15 are simultaneously supplied from the limit output value storage unit 51 to the comparison unit 52. The comparison unit 52 compares the both. When the RGB output values are larger than the limit values, the routine shifts to step ST11, where the processing from step ST11 to step ST17 is repeated.

On the other hand, when the RGB output values are smaller than the limit values, the routine shifts to the processing of step ST19, where the service life display device 60 displays that a specific LED of the light source 15 has reached the end of its service life by the control signal S52 output from the comparison unit 52. Then, the routine returns to the processing of step ST11 whereupon the same operation is repeated.

The light quantity detection method shown in FIG. 2 is the method of measurement by one processing operation by providing time differences for the detections of the light quantities of the LEDs 16 to 18, but there is also other method of performing the measurement and processing in individual flows and further by providing time intervals. The method will be shown next.

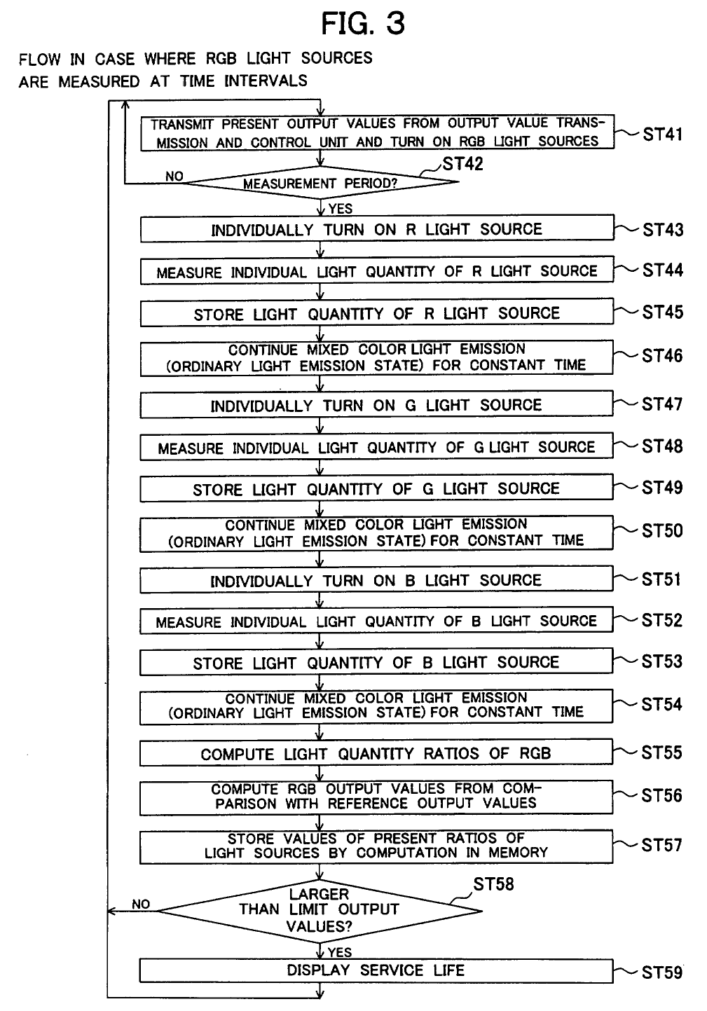

FIG. 3 is a flow chart of an example of independently performing R light quantity measurement (measurement of light quantity of the R-LED 16), G light quantity measurement (measurement of light quantity of the G-LED 17), and B light quantity measurement (measurement of light quantity of the B-LED 18) as three groups. The light quantity measurement method of the respective LEDs of the light source unit 15 is the same as the method shown in FIG. 2, therefore a detailed explanation of the measurement concerning those individual light sources is omitted.

In FIG. 3, the processing of step ST41 and step ST42 is the same as the processing of step ST11 and step ST12 of FIG. 2. It is judged whether the mode is the ordinary lighting mode or the light quantity adjustment mode.

The detection operation of the light quantity of the R light source (red LED) 16 at step ST43 to step ST45 corresponds to the processing from step ST13 to step ST17. By turning on the R light source (RLED 16), the light quantity is measured, and the result thereof is stored.

Thereafter, at step ST46, the R (red) LED, the G (green) LED 17, and the B (blue) LED 18 are driven to continue the emission of the mixed color light (ordinary light emission state) for a constant period.

In the same way for the G light source (G (green) LED 17) as well, the light quantity of the G light source is detected and the data stored at step ST47 to step ST49. At step ST50, the emission of the mixed color light (ordinary light emission state) is continued for a constant period.

In the same way for the B light source (B (blue) LED 18) as well, the light quantity is detected and the data stored at step ST51 to step ST53. At step ST54, the emission of the mixed color light (ordinary light emission state) is continued for a constant period.

The data of the light quantities of the respective LEDs 16 to 18 is used for the processing at step ST55 to step ST59 for the light quantity correction values and display of the service life. The processing method is the same as that from step ST15 to step ST19 shown in FIG. 2.

As explained above, the R-LED 16, G-LED 17, and B-LED 18 may also be measured independently.

Further, the processing for correction of the light quantity shown in FIG. 2 and FIG. 3 may be desirably carried out before the drop in the light quantity due to the deterioration of the respective LEDs of the light source unit 15 becomes a value not permissible in terms of change of the color.

As an example of the light source unit 15, the case of using LEDs was explained. LEDs, as explained above, take a long time to drop in light quantities due to ordinary deterioration, therefore, as the period for the present correction in the light quantity adjustment mode may be for example a period of about once a month in order to maintain sufficient performance.

Further, as shown in FIG. 1, as the sensor (light receiving device) used in the light quantity detection unit 80, a device formed by silicon can be used. A sensor formed by silicon has a wide wavelength sensitivity zone and has a sufficiently fast response speed. Since the response speed is fast, the detection time for the measurement processing may, for example, be reduced to about 1/100 second. Even by sequential independent lighting of each LED at the time of measurement in the light quantity adjustment mode, almost nothing incompatible is noticed by the human eye. Accordingly, there is substantially no degradation of the ordinary lighting mode.

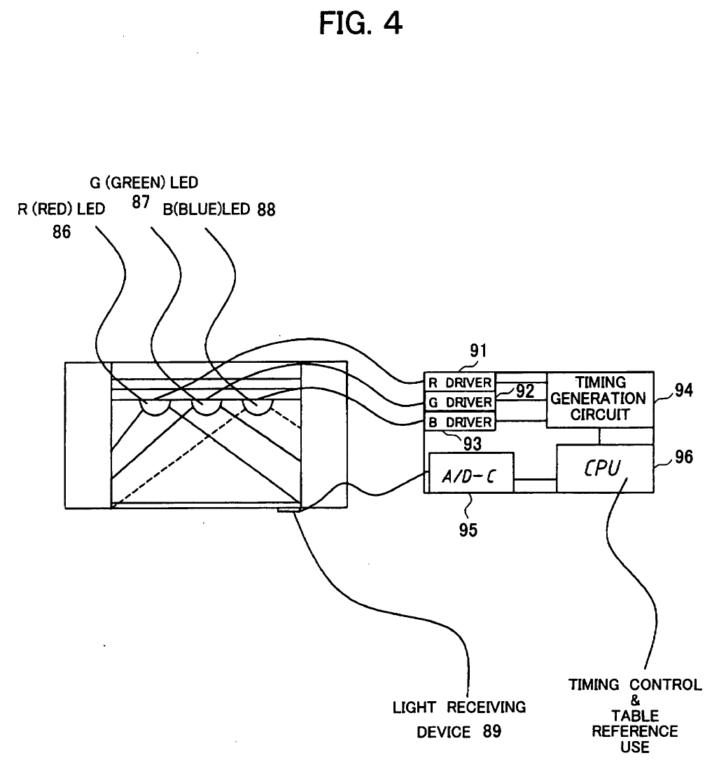

FIG. 4 is a schematic view of the configuration of a variable color illumination apparatus 90.

A light quantity detector comprises a light source unit having an R-LED 86, G-LED 87, and B-LED 88 and a light receiving device 89 for detecting lights emitted from these LEDs.

In the present embodiment, in the same way as the embodiment shown in FIG. 1, the light quantity detector comprises three LED light sources and one light receiving device.

On the other hand, the light source drive circuit and central processing unit comprise an R driver 91, G driver 92, B driver 93, timing generation circuit 94, CPU 96, and A/D conversion unit 95. The operations of these are the same as those shown in FIG. 1.

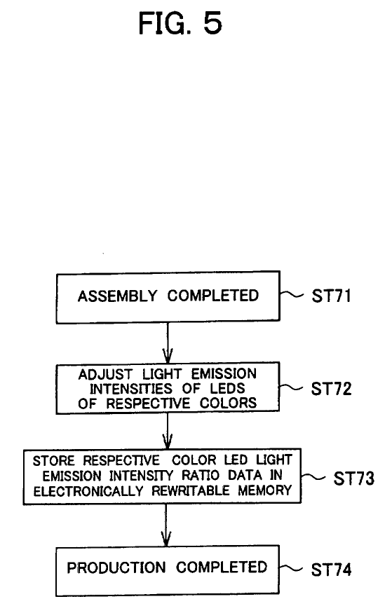

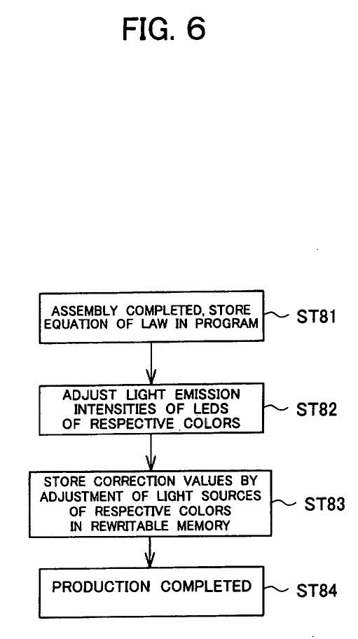

FIG. 5 and FIG. 6 show principal parts of the method of production of the variable color illumination apparatus 90.

FIG. 5 is a flow chart of a first production method as another embodiment. The method of assembly in the production process is not a main object of the present invention, so is omitted.

When the assembly is completed (step ST71), at step ST72, the light emission intensity of each LED is adjusted. This adjustment is repeatedly carried out in accordance with the color temperature to be made variable or the number of required light colors.

At step ST73, each color LED light emission intensity ratio data is stored in an electrically rewritable memory (flash memory etc.) and the production is completed (step ST74). The storing memory corresponds to the production time RGB ratio storage unit 71 shown in FIG. 1.

FIG. 6 is a flow chart of a second production method of another embodiment.

At step ST81, after the completion of assembly, an equation of Planck's law or Wien's law relating to black body radiation is stored in a program storage unit of the memory of the CPU.

At step ST82, the light emission intensities of the respective color light sources (for example R-LED 86, G-LED 87, and B-LED 88) are adjusted. The adjustment is repeatedly carried out in accordance with the number of light sources.

At step ST83, correction values by adjustment of the respective color light sources are stored in the rewritable memory, and the production is completed (step ST84).

In the present method, it is not necessary to make the memory store all adjustment values for all color temperatures of black body radiation.

A spectrum computation equation of black body radiation known as Planck's law is stored in the memory of the CPU (central processing unit, computer), and light emission intensities of the respective light sources according to respective color temperatures are determined while giving each of correction values. In this case, it is sufficient to only store Planck's law and correction values.

The data is preset in the RGB ratio storage unit 71 based on the principle of light color setting. For the correction values stored in the last output value storage unit 72 as well, the RGB ratios are finally determined based on this principle.

Below, the principle of light color setting will be shown.

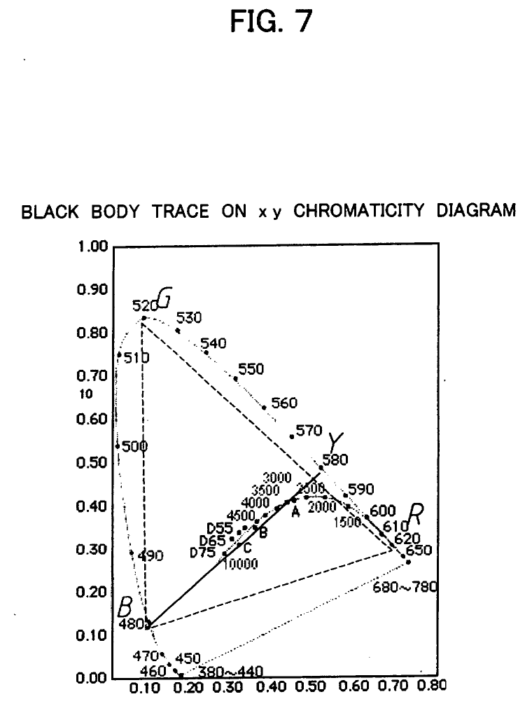

FIG. 7 shows a chromaticity diagram. In the coordinates, when operating an LED shown at the point B shown and emitting light having a wavelength of 480 nm and a LED shown at the point Y and emitting light having a wavelength of 580 nm to form a mixed color, a light color on a line connecting the two points B and Y can be obtained by mixing according to the ratio of light emission intensities of the LEDs of B and Y.

Further, FIG. 7 shows a curve indicating the change of natural light (black body radiation) existing in the natural world due to temperature. The line connecting Y and B explained before and this black body radiation curve are close. According to the light emission intensity ratio of Y and B, as indicated on the coordinates, light emission colors from 3000 K to 7500 K (Kelvin) are obtained.

Next, a case of increasing two light sources to three light sources will be explained. When operating the three LEDs in the chromaticity coordinates of FIG. 7, the LED indicated by the point B and emitting light having the wavelength of 480 nm, the LED indicated by a point G and emitting light having a wavelength of 520 nm, and the LED indicated by a point R and emitting light having a wavelength of 620 nm, to form a mixed color, light colors in a region connecting the three points of the coordinates B, G, and R can be obtained by mixing according to the ratio of light emission intensities of the B, G, and R LEDs. As clear from the chromaticity diagram, colors in the region connecting the three points explained above enable the creation of colors of the majority of the chromaticity diagram.

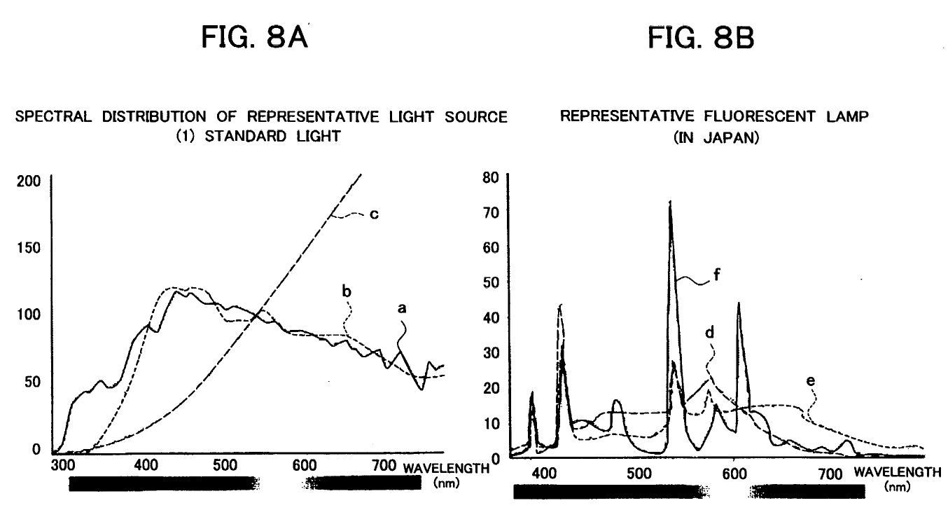

FIG. 8A and FIG. 8B show typical spectral distribution diagrams of light sources.

In FIG. 8A, for example, a curve a shows the standard light D65, reference light of the CIE and ISO (6504 K) based on light of the sun including UV rays. A curve c shows the light intensity with respect to the wavelength of a standard light source of an incandescent lamp (2856K), a curve d of FIG. 8B shows the same for a white fluorescent lamp, a curve e shows the same for a day light color fluorescent lamp, and a curve f shows the same for a three-wavelength type daytime white fluorescent lamp.

It is shown that the standard light of the curve a has a light emission intensity of about 75 or more within a range from 400 nm to 700 nm, and has a substantially uniform light emission intensity. It is shown that the incandescent lamp of the curve c has a small light emission intensity on the short wavelength side, but has a large light emission intensity on the long wavelength side. It is shown that the three-wavelength type daytime white fluorescent lamp of the curve f has peaks at three positions of about 430 nm, 540 nm, and 620 nm and emits a white color.

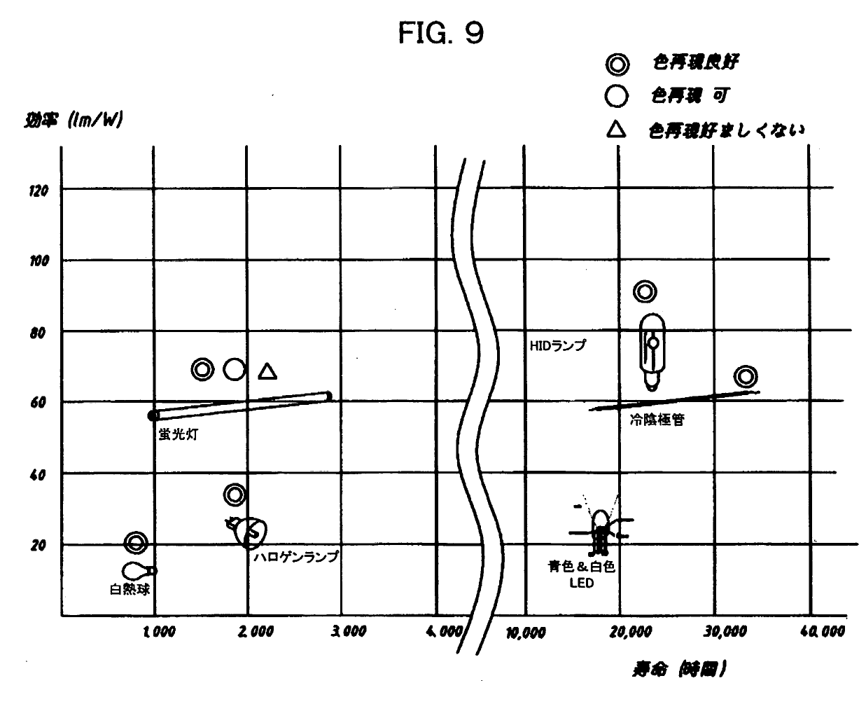

FIG. 9 shows a graph showing the efficiency (lm/W: lumen per watt) and service life (hours) for each light source.

An incandescent lamp has an efficiency of 20 lm/W and a service life of 1,000 hours or less. A halogen lamp has an efficiency of about 35 lm/W and a service life of little less than 2,000 hours. A fluorescent lamp (hot cathode) has an efficiency of 70 lm/W and a service life of 1,500 to 2,200 hours, i.e., has better efficiency than the former.

An HID lamp (metal halide lamp) has a good efficiency, i.e., about 90 lm/W, and also a service life of 20,000 hours or more. The light emission efficiency of a cold cathode tube is about 65 lm/W and its service life is 30,000 hours or more. Further, although the efficiency of a blue and white LED is about 25 lm/W, the characteristic feature of this is that the service life is long, i.e., just under 20,000 hours. Further, among these light sources, the light sources except the blue and white LED are generally good in color reproduction.

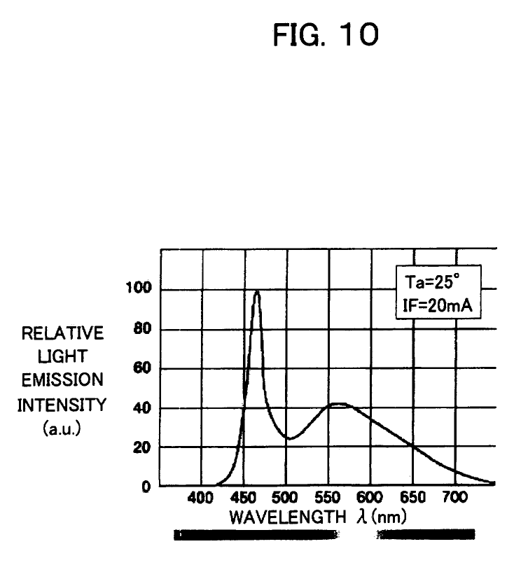

FIG. 10 is a graph of relative light emission intensities with respect to the spectrum of a white LED. A wavelength λ (nm) within a range from 400 nm to 700 nm is plotted on an abscissa, and any scale (a.u.), 0 to 100, of the relative light emission intensity is plotted on an ordinate.

The light emission intensity of a white LED abruptly rises from 420 nm, reaches the maximum first peak (100 a.u.) at about 470 nm, falls to 500 nm after that, increases again, and reaches a second peak (40 a.u.) at about 560 nm. Then, along with the increase of the wavelength, it is steadily reduced and becomes 10 a.u. or less at 700 nm.

Accordingly, it is seen that this white LED has a light emission intensity in the vicinity of 700 nm of 10 a.u. or less and has a relatively very small red color. When an object is illuminated with this light, the red color becomes dull.

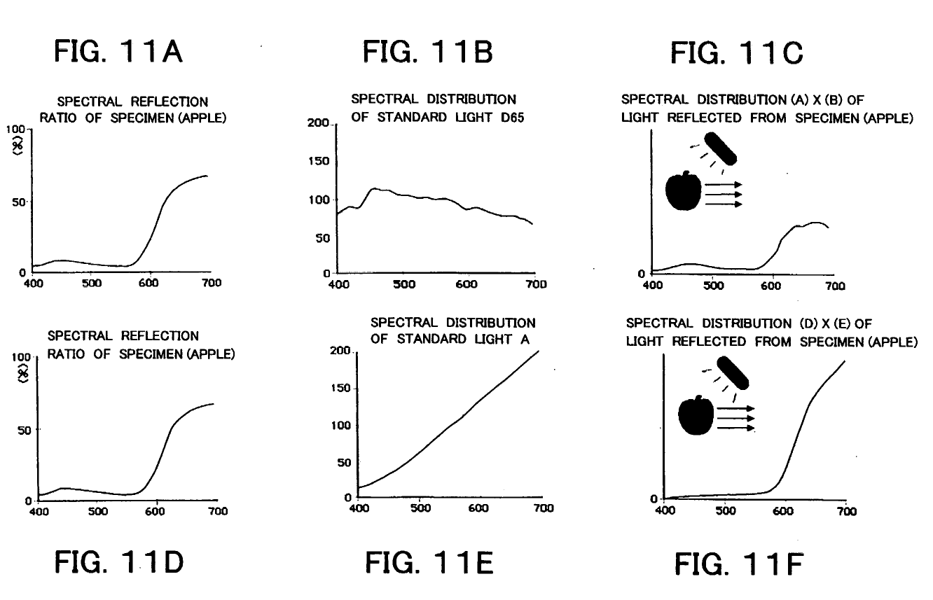

FIG. 11A to FIG. 11F show spectral reflection ratios in a case where light is irradiated to for example a specimen (apple) by using standard light D56 (sunlight) and an incandescent lamp of standard light as light sources.

FIG. 11A shows the spectral reflection ratio of the specimen (apple). The wavelength is plotted on the abscissa. 400 nm to 700 nm are shown. Relative values 0 to 100% of the spectral reflection ratio are plotted on the ordinate. The spectral reflection ratio is 10% or less within the range from 400 nm to 580 nm, abruptly increases when the wavelength becomes 600 nm or more, becomes about 70% at 650 nm, exhibits saturation characteristics after that, and becomes about 70% at 700 nm.

FIG. 11B shows the spectral distribution of the standard light D65. It exhibits about 80 lm/W at 400 nm, reaches a peak of about 120 lm/W at 480 nm, is steadily reduced along with the increase of the wavelength after that, and becomes about 70 lm/W at 700 nm.

FIG. 11C shows the spectral distribution of the reflected light when irradiating a specimen (apple) with standard light. This is obtained by multiplying the spectral reflection ratio of the specimen (apple) of FIG. 11A and the spectral distribution of the standard light of FIG. 11B, therefore, it is seen from the diagram that the spectral distribution of the reflected light within the range from about 600 nm to 700 nm is reduced. This shows that the red color of the specimen (apple) becomes slightly dull.

A case of irradiating the same specimen (apple) (FIG. 11D) by an inca2ndescent lamp of standard light will be explained. The spectral distribution of the light of the incandescent lamp is shown in FIG. 11E. It exhibits about 20 lm/W at 400 nm, shows downwardly convex curve up to 450 nm, steadily increases, exhibits about 25 μm/W at 450 nm, and then linearly increases and becomes about 200 lm/W at 700 nm.

As shown in FIG. 11F, the spectral distribution of the light reflected from the specimen (apple) is obtained by multiplying the spectral reflection ratio of the specimen (apple) of FIG. 11D and the spectral distribution of the standard light of FIG. 11E in the same way as explained before, therefore it is shown that the value of the spectral distribution is small when the wavelength is less than 600 nm and the value abruptly increases at more than 600 nm. This shows that the light on the long wavelength side is enhanced, and the specimen (apple) is red colored more.

In this way, the spectral distribution reflected from the specimen is different according to the spectral distribution characteristic of the light source, therefore a specimen sometimes seems to have a color different from the actual color. In order to improve this, the spectral characteristic of the light source may be changed.

Further, even when the light colors (and light quantities) of the light sources are once set, the light color sometimes changes according to aging when using LEDs for the light source. In such a case, the color can be made to approach the actual color by using the variable color illumination apparatus explained before or its correction method.

Next, another embodiment showing an example of application using the variable color illumination apparatus of the embodiment of the present invention will be shown.

For example, a variable color spot illumination apparatus using three R-LED, G-LED, and B-LED is provided. And by illuminating over a wide angle, a writing implement or other implement, for example, may be illuminated with any colored light for display. In particular, in the case of a variable color spot illumination apparatus, since the light emission ratios of three LEDs can be made variable, display is possible while changing the surroundings by changing the light colors and light quantities.

Further, display emphasizing a specific color is possible by changing the light emission ratios of the LEDs to change the color of the product when irradiating the target product.

Full color illumination using three LEDs explained above may be applied for lighting colorful shops and fields where color is important such as food, apparel, and cosmetics. All types of colors can be reproduced up to natural light (sunlight to incandescent lamps) in accordance with the object.

As an embodiment of spot illumination, it is possible to make the projection angle of a spotlight variable and use the spotlight as a lamp for reading books. For the light source, a plurality of for example three LEDs may be used to form a three-wavelength daytime white fluorescent lamp. Further, the light color may be made variable in accordance with the surroundings (room) for reading books.

Further, in spot illumination, narrow angle illumination is possible conversely to wide angle illumination.

In the case of spot illumination using LEDs etc., there are characteristic features of low power consumption, a long service life of 500,000 hours or more, and a small size.

In addition to the above example of application, there also exists a linear light unit having LED light sources arranged in a line. This provides linear lights above and below glass or acrylic shelves and reflects the light from the light sources at the shelves to make the shelves brighter and brighten the area under the shelves as well.

As another embodiment of a linear light, a linear light can be provided in an end of a film poster and used as the light source thereof. Other than this, it can be used as panel light for observation of X-ray film in a hospital.

Further, since the light color and light quantity can be made variable, this can be used as a light source in a beauty parlor or a dentist's office.

In this way, the variable color illumination apparatus of the embodiment of the present invention enables more suitable color illumination in accordance with the surroundings and can reproduce colors stably for a long time.

As explained above, it is known that even if running the same current to light sources, for example LEDs, the characteristics of the LEDs will change due to aging. This change is peculiar to each LED. Due to the change of characteristics along with aging, the initially composed light could not be maintained at the same color. However, when using the variable color illumination apparatus of the embodiment of the present invention, by measuring lights generated from the LEDs or other light sources by a light receiving device in the light quantity adjustment mode, measuring the values changed from those of the initial settings by one light receiving device in a time sequential manner so that there is no overlap, calculating correction values from the measurement results, and correcting the currents run through each of LEDs, it becomes possible to maintain a constant color.

Further, it is possible to detect the light quantities by a single light receiving device from among the plurality of light sources, find the light colors and light quantities, and generate any mixed color light, so this apparatus can be used for various types of light sources and the photo-detector can be made small in size.

Further, in the variable color illumination apparatus of the embodiment of the present invention, the circuits and/or devices are small in size, so the current consumption can be reduced. Further, when using LEDs for the light sources, since the service life is longer in comparison with conventional light sources, the apparatus can be applied to various fields as explained above.

1. A variable color illumination apparatus operating in an ordinary lighting mode for simultaneously turning on respective light sources and in a light quantity adjustment mode for adjusting light quantities of the respective light sources,
the variable color illumination apparatus comprising:
light sources (15) of at least two colors for composing light,
a control device (30, 21 to 23) for independently performing light adjustment of said respective light sources,
single light receiving device (80) for detecting light emitting amounts of the light sources,
a memory device (70) for storing a light quantity ratio of each of said plurality of light sources preset for obtaining a desired light color, and
a processing device (50:51 to 58) for finding a difference between a light quantity ratio preset for obtaining a desired light color stored in said memory device and a light emitting amount detected at said light receiving device,
said control device simultaneously driving said light sources in said ordinary lighting mode,
said control device sequentially driving said plurality of light sources at time intervals in said light quantity adjustment mode, said processing device finding the difference between a light quantity ratio preset for obtaining a desired light color stored in said memory device for a light source driven at that time and a light emitting amount of said driven light source detected at said light receiving device and transmitting the difference to said control device (30), and said control device driving the light source by using the input difference as correction output of said driven light source so as to control the light emitting amount of the light source.

2. A variable color illumination apparatus as set forth in claim 1, wherein said processing device has a time adjusting means (58) for generating a time interval for sequentially driving said light sources and a time required for light quantity detection in said light quantity adjustment mode.

3. A variable color illumination apparatus as set forth in claim 1, wherein:
said processing device (54) outputs a control signal (S54) for operating said respective light sources in time sequence and turning on the respective light sources for a short time to said control device (30) in said light quantity adjustment mode, and
light quantity detections of said respective light sources in said light receiving device (80) are carried out in a time sequence.

4. A variable color illumination apparatus as set forth in claim 3, wherein processing of said light quantity adjustment mode is carried out in a predetermined short time between ordinary lighting modes simultaneously turning on said respective light sources.

5. A variable color illumination apparatus as set forth in claim 1, further comprising a second memory device for storing limit values of light source light adjustment control values and a warning means for informing an end of service life of said light source in a case where an output value calculated from a light quantity of said respective light sources obtained by said difference output from said processing device to said control device exceeds said limit value.
